(19) United States
(12) Patent Application Publication
(10) Pub. No.: US 2003/0166486 A1
(43) Pub. Date: Sep. 4, 2003

(54) Fabric conditioning compositions

(76) Inventors: David Machin, Merseyside (GB); Laurent Soubiran, Merseyside (GB); Gary Cahill, Merseyside (GB); Shimei Fan, Chicago, IL (US); John Francis Hubbard, Merseyside (GB)

Correspondence Address: UNILEVER, PATENT DEPARTMENT, 45 RIVER ROAD, EDGEWATER, NJ, 07020, US

(21) Appl. No.: 10/204,888

(22) PCT Filed: Jan. 22, 2001
(86) PCT No.: PCT/EP01/00639

(30) Foreign Application Priority Data
Feb. 8, 2000 (GB) 0002876.1

(51) Int. Cl. C11D 3/00; D06L 1/00

(52) U.S. Cl. 510/327; 510/329; 510/330; 510/504; 510/515

(57) ABSTRACT

A fabric conditioning composition comprising a cationic fabric softening compound dispersed in water is found to have surprisingly improved viscosity stability if a stabilising system comprising at least one salt of a multivalent inorganic anion or non-sequestering multivalent organic anion is present. The invention is particularly suitable for use with quaternary ammonium material comprising a compound having two C12-18 alkyl or alkenyl groups connected to the molecule via at least one ester link. Preferably, the mixture comprises sodium chloride and sodium sulphate. Preferably, there is additionally at least one salt of a univalent anion.

### TECHNICAL FIELD

The present invention relates to fabric conditioning compositions. In particular, the present invention relates to fabric conditioning compositions with enhanced viscosity stability characteristics and improved appearance.

### BACKGROUND AND PRIOR ART

Fabric conditioners are commonly used to deposit a softening compound onto a fabric. Typically, such compositions contain a water-insoluble quaternary ammonium fabric softening agent dispersed in water at a level of softening agent up to 7% by weight, in which case the compositions are considered dilute, or at levels from 7% to 50% by weight, in which case the compositions are considered concentrates.

One of the problems associated with fabric softening compositions is the physical instability of such compositions when stored. Physical instability manifests itself as a thickening on storage of the compositions to a level where the composition can no longer be poured and can even lead to the formation of a gel which cannot be redispersed. This problem is accentuated by having a concentrated composition and by storage at low or high temperatures. With concentrated compositions comprising biodegradable ester-linked quaternary ammonium compounds, the problem of physical instability is more acute than with traditional quaternary ammonium compounds which do not have any ester links.

Conventional dilute fabric conditioners contain a cationic surfactant as the softening agent and frequently contain an electrolyte such as calcium chloride to maintain the formation in a pourable condition. However, the formation of a stable concentrated product is not so easily achieved. The viscosity, pourability and flowability characteristics of conventional fabric conditioners are not maintained if the level of cationic softening active exceeds 8% by weight of the composition, even in the presence of calcium chloride. In such concentrated systems, phase separation or gelling occurs when the level of cationic softening agent exceeds 8% by weight.

Concentrated rinse conditioners and physical stability on storage at a range of temperatures are, however, desirable.

In the past, physical stability of rinse added fabric softener compositions has been improved by the addition of viscosity control agents or anti-gelling agents. For example in EP 13780 (Procter & Gamble), viscosity control agents are added to certain concentrated compositions. The agents may include C₁₀-C₁₈ fatty alcohols. European patent application EP-A-0637625 (Procter & Gamble) includes at least 10% by weight of a mixture of aromatic acids, especially benzoic acid and salicylic acid, to stabilise concentrated fabric softeners.

Indian Patent number 181477 discloses that physical stability of fabric conditioning compositions can be obtained by using a bi-electrolyte system which comprises a hydroxy carboxylic acid, preferably an aromatic hydroxy carboxylic acid and a halide of alkali or alkaline earth metal.

WO 96/21714 discloses a method of rinsing dyed or white fabrics in a fabric rinse composition comprising a chelating agent, which may be a sequestering agent for heavy metal ions. However, it has been found that large quantities of sequestering agent can lead to instability in rinse conditioner compositions.

The present invention sets out to provide fabric conditioning compositions with improved viscosity stability characteristics and appearance without resorting to complex or expensive additives.

The present inventors have discovered that electrolytes comprising multivalent inorganic or non-sequestering organic anions are particularly effective at improving storage stability, particularly at low temperature.

### DEFINITION OF THE INVENTION

According to a first aspect, the present invention provides a fabric conditioning composition comprising a cationic fabric softening compound dispersed in water, the water having dissolved therein at least one salt of a multivalent inorganic anion or multivalent non-sequestering organic anion.

In another aspect, the present invention provides the use of at least one salt of a multivalent inorganic anion or non-sequestering multivalent organic anion to improve the viscosity stability characteristics of a rinse conditioner composition comprising a cationic fabric softening compound dispersed in water.

In a further aspect the present invention provides a rinse conditioner comprising the fabric conditioning composition of the invention.

### DETAILED DESCRIPTION OF THE INVENTION

Salt of Multivalent Anion

Preferably, the multivalent anion is divalent. Sulphate is particularly preferred. The counter ion is preferably an alkaline earth metal, ammonium or alkalimetal. Preferably, it comprises an alkalimetal cation or ammonium. Typically preferred are sodium, potassium or ammonium salts. There may be more than one salt of a multivalent anion present, and they may differ in the choice of anion, cation or both. Sodium sulphate is particularly preferred.

Salts of organic sequestering anions, such as ethylene diamine disuccinate are not suitable.

The total quantity of salt of multivalent anion is suitably in the range 0.1-2.0, more preferably 0.2-1.5, most preferably 0.2-1.2% by weight.

It is essential that the salt of the multivalent anion is substantially water soluble. Preferably, the salt of the multivalent anion has a solubility in excess of 1 gram per litre, preferably in excess of 25 grams per litre.

Salt of Univalent Anions

The present inventors have further discovered that compositions containing salts of multivalent anions can, under some circumstances, have a chalky particulate appearance.

It is desirable, though not essential to the present invention, that the fabric conditioning compositions have an attractive appearance.

The present inventors have further discovered that a fabric conditioning composition containing salts of multivalent inorganic or non-sequestering organic anions can have an attractive non-chalky appearance if a salt of a univalent anion is additionally present. Surprisingly, a synergistic effect is obtained, whereby attractive appearance is obtained whilst good stability is maintained.

It is preferred that the salt of the univalent anion comprises an alkali metal or alkaline earth metal salt. It is particularly preferred that the cation is sodium, potassium or ammonium. The univalent anion may be any suitable univalent anion. It is preferably an inorganic anion, and is preferably a halide, most preferably chloride. There may be more than one salt of a univalent anion present. They may differ in the choice of anion, cation, or both. Particularly preferred are calcium chloride, sodium chloride, ammonium halide, rare earth halides, such as lanthanum chloride and alkali metal salts of organic acids such as sodium acetate and sodium benzoate.

A particularly preferred combination comprises a mixture of sodium sulphate with an electrolyte selected from the group consisting of sodium chloride, calcium chloride, potassium chloride and ammonium chloride.

The total quantity of salt of univalent anion is suitably in the range 0.05-2.0%, more preferably 0.1-1.5%, most preferably 0.2-1.0% by weight, based on the total weight of the composition.

Preferably, the total weight of salts of univalent and multivalent anions is in the range 0.5-3.0%, more preferably 1.0-2.0%, more preferably 1.0-1.5% by weight, based on the total weight of the composition.

The weight ratio of salt of univalent anion to salt of multivalent anion is suitably in the range 10:1 to 1:10, more preferably 5:1 to 1:5, most preferably 3:1 to 1:3.

Preferably, the total weight of salts of univalent and multivalent anions is in the range 0.5-3.0%, more preferably 1.0-2.0%, more preferably 1.0-1.5%.

The weight ratio of salt of univalent anion to salt of multivalent anion is suitably in the range 10:1 to 1:10, more preferably 5:1 to 1:5, most preferably 3:1 to 1:3.

The salt of the univalent anion must be substantially water soluble. Preferably, it has a solubility in excess of 1 gram per litre, more preferably in excess of 20 grams per litre.

Without wishing to be bound by theory, it is believed that thickening on storage occurs particularly at low temperature with conditioner compositions based on formulations comprising ester-linked quaternary ammonium softening compounds, and is due to the formation of a hydrated solid. It is believed that sodium sulphate and other salts of multivalent inorganic or non-sequestering organic anions prevent the formation of hydrated solid by interacting with the counter ion of the quaternary ammonium compound.

Fabric Softening Compound

In the first instance any suitable fabric softening compound is suitable for use with the present invention, in particular nonionic softening compounds and cationic softening compounds.

It is preferred if the fabric softening compound is cationic in nature. Preferably the cationic fabric softening compound of the invention is a quaternary ammonium material. Preferably the quaternary ammonium material has two long chain alkyl or alkenyl chains with an average chain length greater than C₁₄, more preferably each chain has an average chain length greater than C₁₆, more preferably at least 50% of each long chain alkyl or alkenyl group has a chain length of C₁₈.

It is preferred if the long chain alkyl or alkenyl groups of the fabric softening compound are predominantly linear.

The cationic fabric softening compositions used in the invention are compounds which provide excellent softening, characterised by a chain melting Lβ to Lα transition temperature greater than 25° C., preferably greater than 35° C., most preferably greater than 45° C. This Lβ to Lα transition can be measured by differential scanning calorimetry (DSC) as defined in the “Handbook of Lipid Bilayers, D Marsh, CRC Press, Boca Raton Fla., 1990 (pages 137 and 337).

It is preferred if the softening compound is substantially insoluble in water. Substantially insoluble fabric softening compounds in the context of this invention are defined as fabric softening compounds having a solubility less than 1×10⁻³ wt % in demineralised water at 20° C., preferably the fabric softening compounds have a solubility less than 1×10⁻⁴ wt %, most preferably the fabric softening compounds have a solubility at 20° C. in demineralised water from 1×10⁻⁶ to 1×10⁻⁸ wt %.

It is especially preferred if the fabric softening compound is a water insoluble quaternary ammonium material which comprises a compound having two C₁₂₋₁₈ alkyl or alkenyl groups connected to the molecule via at least one ester link. It is more preferred if the quaternary ammonium material has two ester links present. The especially preferred ester-linked quaternary ammonium material for use in the invention can be represented by the formula:

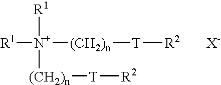

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; T is

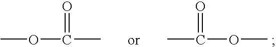

X⁻ is any suitable anion including halide, acetate and lower alkosulphate ions and n is 0 or an integer from 1-5.

Especially preferred materials within this formula are di-alkenyl esters of triethanol ammonium methyl sulphate and N-N-di (tallowoyloxy ethyl) N,N-dimethylammonium chloride. Commercial examples of compounds within this formula include Tetranyl AHT-1 (di-hardened oleic ester of triethanol ammonium methyl sulphate 80% active), AO-1(di-oleic ester of triethanol ammonium methyl sulphate 90% active), L5/90 (palm ester of triethanol ammonium methyl sulphate 90% active (supplied by Kao corporation) and Rewoquat WE15 (C₁₀-C₂₀ and C₁₆-C₁₈ unsaturated fatty acid reaction products with triethanolamine dimethyl sulphate quaternised 90% active), ex Witco Corporation.

A second preferred type of quaternary ammonium material can be represented by formula:

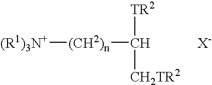

wherein R¹, R², X⁻, n and T are as defined above.

Preferred materials of this class such as 1,2 bis[hardened tallowoyloxy]-3-trimethylammonium propane chloride and their method of preparation are, for example, described in U.S. Pat. No. 4,137,180 (Lever Brothers). Preferably these materials comprise small amounts of the corresponding monoester as described in U.S. Pat. No. 4,137,180 for example 1-hardened tallowoyloxy-2-hydroxy trimethylammonium propane chloride.

It is advantageous for environmental reasons if the quaternary ammonium material is biologically degradable.

The fabric softening agent may also be polyol ester quats (PEQs) as described in EP 0638 639 (Akzo).

The present invention is found to be particularly effective for liposomal dispersions of the above mentioned fabric softening components. It is also particularly effective for dispersions containing unsaturated softener systems.

If the quaternary ammonium compound comprises hydrocarbyl chains formed from fatty acids or fatty acyl compounds which are unsaturated or at least partially unsaturated (e.g. where the parent fatty acid or fatty acyl compound from which the quaternary ammonium compound is formed has an iodine value of from 5 to 140, preferably 5 to 100, more preferably 5 to 60, e.g. 5 to 40) then the cis:trans isomer weight ratio in the fatty acid or fatty acyl compound is greater than 20:80, preferably greater than 30:70, more preferably greater than 40:60, e.g. 70:30 or more. It is believed that higher ratios of cis to trans isomer afford the compositions comprising the quaternary ammonium compound better low temperature stability and minimal odour formation.

Saturated and unsaturated fatty acids or acyl compounds may be mixed together in varying amounts to provide a compound having the desired iodine value.

Alternatively, fatty acids or acyl compounds may be hydrogenated to achieve lower iodine values.

Of course the cis:trans isomer weight ratios can be controlled during hydrogenation by methods known in the art such as by optimal mixing, using specific catalysts and providing high H₂ availability.

Composition pH

The compositions of the invention preferably have a pH of at least 1.5 and/or less than 5, more preferably at least 2.5 and/or less than 4.

Additional Stabilising Agents

The compositions of the present invention may contain optional additional stabilising agents.

Compositions of the invention may also contain nonionic stabilisers. Suitable nonionic stabilisers which can be used include the condensation products of C₈-C₂₂ primary linear alcohols with 10 to 25 moles of ethylene oxide. Use of less than 10 moles of ethylene oxide, especially when the alkyl chain is in the tallow range, leads to unacceptably high aquatic toxicity. Particularly preferred nonionic stabilisers include Genapol T-110, Genapol T-150, Genapol T-200, Genapol C-200, Genapol C-100, Genapol C-150 all ex Hoechst, Lutensol AT18 ex BASF, or fatty alcohols for example Laurex CS, ex Albright and Wilson or Adol 340 ex Sherex (all trade marks). Preferably the nonionic stabiliser has an HLB value of from 10 to 20, more preferably 12 to 20. Preferably, the level of nonionic stabiliser is within the range of from 0.1 to 10% by weight, more preferably from 0.5 to 5% by weight, most preferably from 1 to 4% by weight, based on the total weight of the composition.

In a preferred embodiment, the fabric conditioning compositions according to the present invention further comprise an unsaturated C₈-C₂₄ fatty acid as an additional viscosity stabiliser, wherein the weight ratio of quaternary ammonium material to unsaturated fatty acid is greater than 10:1, preferably greater than 12:1. This is further described in our co-pending application no. GB 0002877.9. The unsaturated fatty acid may be added in association with other materials, for example saturated fatty acid. The unsaturated fatty acid preferably represents 10-50% by weight, more preferably 15-30% by weight of the free fatty acid. The total level of unsaturated fatty acid in the composition is suitably in the range 0.1-1.5%, more preferably 0.15-1.0%, most preferably 0.2-0.8% by weight based on the total weight of the composition. These measures do not include unsaturated fatty acid which originates through a dissociation of fabric softening compounds manufactured with unsaturated fatty acids.

Additional Viscosity Control Agent

If the product is a liquid it may be advantageous if a viscosity control agent is present. Any viscosity control agent used with rinse conditioners is suitable for use with the present invention, for example biological polymers such as Xanthan gum (Kelco ex Kelsan and Rhodopol ex Rhodia), Guar gum (Jaguar ex Rhodia), starches and cellulose ethers. Synthetic polymers are useful viscosity control agents such as polyacrylic acid, poly vinyl pyrolidone, polyethylene, carbomers, cross linked polyacrylamides such as Acosol 880/882 polyethylene and polyethylene glycols.

Other Ingredients

The composition can also contain coactives such as fatty acids, for example C₈-C₂₄ alkyl or alkenyl monocarboxylic acids, or polymeric carboxylic acids. Preferably, unsaturated fatty acid coactives are used.

The level of fatty acid material is preferably more than 0.1% by weight, more preferably more than 0.2% by weight, based on the total weight of the composition. Especially preferred are concentrates comprising from 0.5 to 20% by weight of fatty acid, more preferably 1% to 10% by weight. The weight ratio of fabric softening compound to fatty acid material is preferably from 10:1 to 1:10.

The composition can also contain one or more optional ingredients, selected from non-aqueous solvents, pH buffering agents, perfumes, perfume carriers, colorants, hydrotropes, antifoaming agents, polymeric or other thickening agents, opacifiers, and anti-corrosion agents.

It is preferred if the compositions of the invention do not contain alkoxylated β-sitosterol compounds.

The composition of the present invention optionally includes an additional fabric treatment agent such as insect control agents, hygiene agents or compounds used to prevent the fading of coloured fabrics. Suitable fabric treatment agents are disclosed in WO 97/44424.

Processing

Compositions according to the present invention may be produced by any suitable method. Preferably, the compositions are produced by a melt method. In the melt method, a cationic fabric softening compound is melted and mixed with optional additional ingredients such as fatty acid and stabilising surfactant if required. A homogeneous mixture is produced.

Separately, an aqueous solution of the water-soluble components (electrolyte for example) is prepared at elevated temperatures (suitably in the range 50-100° C., preferably 60-85° C.). The molten active mixture is added slowly to the aqueous solution with stirring, preferably with additional longitudinal shear generated using a recycling loop. After a few minutes, perfume (if required) is added slowly and the mixture is stirred slowly to ensure thorough mixing. Finally, the composition is cooled at ambient temperature with continual stirring. This process can be modified in a number of ways.

1. Stabilising surfactant can be added directly to the aqueous solution. Preferably, this takes place after all the components have been mixed, whilst the composition is cooling. Perfume can be included at this stage as an emulsion.

2. Electrolyte may be added sequentially (in for example four portions) at the same time as the molten active is added to the aqueous solution.

The present invention will be further described by way of example only with reference to the following non-limiting examples.

### EXAMPLES

Fabric conditioning compositions are produced by the following method. Cationic softener, fatty acid and stabilising surfactant (if present) are melted together to form a co-melt. The co-melt is stirred to ensure homogeneity. Separately, an aqueous solution of electrolyte and polyethylene glycol, if present, at a temperature in the range 60-85° C. is prepared. The co-melt is slowly added to the aqueous solution with stirring. After a few minutes, perfume is added slowly and the mixture is further stirred to ensure thorough mixing. The resulting composition is cooled to ambient temperature with constant stirring.

The viscosity stability characteristics of the resulting dispersions are measured by measuring the viscosity after various periods of storage and various temperatures.

Viscosity is measured using a Haake VT 501 (Trade Mark) cup and bob system.

Compositions Tested

### Example 1

19.4% DEEDMAC¹

0.67% fatty acid 5166²

0.9% perfume

0.2% Genapol C200³

0.74% sodium sulphate

0.74% sodium chloride

1% PEG 1500⁴

water and minors to 100%

### Example 2

14.5% DEEDMAC¹

0.5% fatty acid 5166²

0.3% Genapol C200³

0.5% sodium sulphate

0.5% sodium chloride

1% PEG 1500⁴

0.9% perfume

water and minors to 100%

### Example 3

15.2% DEEDMAC¹

0.13% fatty acid 5166²

0.5% Genapol C200³

0.6% sodium chloride

0.6% sodium sulphate

water and minors to 100%

### Example 4

14.6% DEEDMAC¹

0.37% Pristerine 4916⁵

0.2% Genapol C200³

0.9% perfume

1.0% sodium sulphate

0.2% sodium chloride

water and minors to 100%

### Example 5

14.9% DEEDMAC¹

0.37% Wet Step Stearine⁶

0.25% Genapol C200³

1.0% perfume

0.2% sodium sulphate

1.0% sodium chloride

water and minors to 100%

### Example 6

14.9% DEEDMAC¹

0.37% Wet Step Stearine⁶

0.25% Genapol C200³

1.0% perfume

0.8% sodium sulphate

0.4% sodium chloride

water and minors to 100%

### Example 7

14.9% DEEDMAC¹

0.37% Wet Step Stearine⁶

0.25% Genapol C200³

1.0% perfume

0.6% sodium sulphate

0.6% sodium chloride

water and minors to 100%

### Example 8

15% HEQ⁷

0.9% perfume

0.5% sodium sulphate

0.6% sodium chloride

water and minors to 100%

### Example 9

19% HEQ⁷

1% perfume

1% sodium sulphate

0.2% sodium chloride

water and minors to 100%

### Example 10

16% HEQ⁷

0.9% perfume

0.7% sodium chloride

0.2% sodium sulphate

water and minors

### Example 11

10% HEQ⁷

0.8% perfume

0.7% sodium chloride

0.1% sodium sulphate

water and minors

### Example 12

15% HEQ⁷

0.9% perfume

0.8% sodium sulphate

water and minors

### Comparative Example A

14.9% DEEDMAC¹

0.37% Wet Step Stearine⁶

0.25% Genapol C200³

1.0% perfume

1.2% calcium chloride

water and minors to 100%

All quantities are in parts or percent by weight, based on the total weight of the composition, unless indicated otherwise.

Notes

1. DEEDMAC is di[2-(hardened tallowoyloxy)ethyl]dimethylammonium chloride. The raw material is supplied as quaternary ammonium compound, hardened tallow fatty acid and isopropanol in a weight ratio: 83:2:15. The percentage quoted includes the associated fatty acid.

2. Fatty acid 5166 is 21% unsaturated tallow fatty acid, ex Unichema.

3. Genapol C200 is coco alcohol ethoxylated with 20 moles of ethylene oxide, ex Hoechst.

4. PEG 1500 is poly(ethylene) glycol of mean molecular weight 1500.

5. Pristerine 4916 is hardened tallow fatty acid, ex Unichema.

6. Wet Step Stearine is 19% unsaturated tallow fatty acid, ex Unichema.

7. HEQ is trimethyl ammonium 2,3 diacyloxypropane chloride, ex Clariant.

Results

All of the examples according to the present invention have an attractive milky non-chalky appearance.

Viscosity (mPa.s at 106s⁻¹ and ambient temp.)

| | after 1 wk | after 5 wks | after 5 wks |
|---|---|---|---|
| Example | at ambient | at 0° C. | at 37° C. |
| A | 50 | 300 | 115 |
| 6 | 58 | 100 | 59 |
| 7 | 50 | 101 | 71 |
| 8 | 61 | 98 | 85 |
| 9 | 22 | 51 | 29 |
| 10 | 90 | 130 | 105 |
| 11 | 99 | 122 | 112 |
| 12 | 31 | 63 | 45 |

It can be seen that compositions 6, 7, 8 and Comparative Example A have very similar viscosities after one week storage at ambient temperature.

Examples 6 and 9 shows substantially no increase in viscosity upon storage at 37° C. for 5 weeks. Examples 7, 8, 10, 11 and 12 produces a small increase in viscosity on storage at 37° C. for 5 weeks. Comparative Example A produces a large increase in viscosity, indicating poor viscosity stability.

The effect on viscosity on storage at 0° C. for 5 weeks are even more pronounced. Comparative Example A produces a severe increase in viscosity.

1. A fabric conditioning composition comprising an ester-linked quaternary ammonium cationic fabric softening compound dispersed in water, the water having dissolved therein at least one alkali metal or alkaline earth metal salt of a multivalent inorganic anion.

2. A fabric conditioning composition according to claim 1 in which the multivalent anion is divalent.

3. A fabric conditioning composition according to any preceding claim, in which the total quantity of salt of multivalent anion is in the range 0.1-2.0 by weight, based on the total weight of the composition.

4. A fabric conditioning composition according to any preceding claim, further comprising at least one salt of a univalent anion.

5. A fabric conditioning composition according to claim 4, wherein the univalent anion is a halide.

6. A fabric conditioning composition according to claim 4 or 5, in which the total quantity of salt of univalent anion is in the range 0.05-2.0% by weight, based on the total weight of the composition.

7. A fabric conditioning composition according to any preceding claim, in which the fabric softening compound is a quaternary ammonium material which comprises a compound having two C₁₂₋₁₈ alkyl or alkenyl groups connected to the molecule via at least one ester link.

8. A rinse conditioner comprising the fabric conditioning composition of any one of claims 1 to 7.

9. Use of at least one salt of a multivalent inorganic anion or non-sequestering multivalent organic anion to improve the low temperature viscosity stability characteristics of a rinse conditioner composition comprising a cationic fabric softening compound dispersed in water.
